(19) United States
(12) Patent Application Publication
(10) Pub. No.: US 2008/0211996 A1
(43) Pub. Date: Sep. 4, 2008

(54) Optical Film, Polarizing Plate and Liquid Crystal Display Device

(75) Inventors: Yukito Saitoh, Kanagawa (JP); Junichi Hirakata, Kanagawa (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/662,063

(22) PCT Filed: Sep. 7, 2005
(86) PCT No.: PCT/JP2005/016861

§ 371 Date: Feb. 25, 2008

(30) Foreign Application Priority Data
Sep. 7, 2004 (JP) 2004-259441

(51) Int. Cl. G02F 1/13363; G02B 5/30; G02F 1/1335

(52) U.S. Cl. 349/96; 359/500; 349/194

(57) ABSTRACT

A novel optical film is disclosed. The optical film comprises an optically anisotropic layer comprising oriented optical elements, wherein the optical elements are oriented in the optically anisotropic layer with an order parameter, which expresses the degree of orientation of said optical elements, varying in the direction of film thickness.

### TECHNICAL FIELD

The present invention relates to an optical film, and a polarizing plate and a liquid crystal display device employing the same.

### BACKGROUND ART

Liquid crystal display device comprises a liquid crystal cell and polarizing plates. The polarizing plate generally has protective films and a polarizing film, and is obtained typically by dying the polarizing film composed of a polyvinyl alcohol film with iodine, stretching, and being stacked on both surfaces thereof with the protective films. A transmissive liquid crystal display device is configured by attaching the polarizing plate on both sides of the liquid crystal cell, occasionally having one or more transparent films having an optical compensation function optionally arranged therein. A reflective liquid crystal display device is configured generally by arranging a reflector plate, the liquid crystal cell, one or more transparent films, and the polarizing plate in this order. The liquid crystal cell comprises liquid-crystalline molecules, two substrates encapsulating the liquid-crystalline molecules, and electrode layers applying voltage to the liquid-crystalline molecules. The liquid crystal cell switches ON and OFF displays depending on variation in orientation state of the liquid-crystalline molecules, and is applicable both to transmission type and reflective type, of which display modes ever proposed include TN (twisted nematic), IPS (in-plane switching), OCB (optically compensatory bend) and VA (vertically aligned), ECB (electrically controlled birefringence).

The transparent film having an optical compensation function has been applied to various liquid crystal display devices in order to cancel coloration of images, and to expand the viewing angle. Stretched birefringence film was one conventional choice (see Japanese Laid-Open Patent Publication “Tokkaihei” No. 2-247602, for example). However in recent years, there has been proposed use of a transparent film comprising a transparent support and a layer comprising discotic (discotic) molecules thereon (see Japanese Laid-Open Patent Publication “Tokkaihei” No. 7-191217 and European Patent No. 0911656, for example). Such a transparent film is produced by coating a composition comprising a discotic compound on an orientation film disposed on a transparent support, allowing the discotic molecules to orient under heating at a temperature higher than the orientation temperature, and fixing the resultant orient state.

The discotic compound generally exhibits a large birefringence, and a variety of orientation forms. Use of the discotic compound made it possible to obtain optical characteristics which have never been obtained by the conventional stretched birefringent film. Because of such wide variety of orientation forms, it is necessary to control the orientation state in order to allow the discotic compound to exhibit desired optical characteristics.

In an exemplary case where a liquid crystal cell of the TN mode or the OCB mode is optically compensated using the discotic compound, it is generally believed that angle of inclination (average tilt angle) of the disk plane of the discotic compound preferably varies in the direction of thickness of the liquid-crystalline compound layer, so as to achieve hybrid orientation (see Japanese Laid-Open Patent Publication “Tokkaihei” Nos. 7-191217, 9-211444 and 11-316378, for example). Methods of controlling the orientation are important in fabrication of this sort of transparent films having an optical compensation function.

### DISCLOSURE OF THE INVENTION

In order to give more accurate optical compensation function, optical films will be required to exhibit a distribution of optical anisotropy corresponded to the orientation distribution of liquid crystal in a liquid crystal panel. The orientation distribution of liquid crystal in a liquid crystal panel is not uniform in the direction of thickness of the liquid crystal panel. It is therefore necessary also for a film, used for optical compensation of such liquid crystal panel, to have a non-uniform distribution of anisotropy in the direction of film thickness, in order to ensure a thorough optical compensation. In the prior art, the liquid crystal molecules of the optically anisotropic layer of the transparent film was uniformly oriented with the aid of the alignment film (interfacial treatment) over a range from the interface with the alignment film to the interface with the air, so that it was very difficult to arbitrarily control the distribution in the direction of film thickness.

Therefore, an object of the present invention is to provide a liquid crystal display device, in particular a liquid crystal display device employing TN mode, in which a liquid crystal cell is optically compensated in an accurate manner, so as to ensure a high contrast even under large viewing angles.

Another object of the present invention is to provide an optical film capable of optically compensating a liquid crystal cell, in particular a liquid crystal cell employing TN mode, and contributive to increase in the contrast under large viewing angles.

In one aspect, the present invention provides an optical film comprising an optically anisotropic layer comprising oriented optical elements, wherein the optical elements are oriented in the optically anisotropic layer with an order parameter, which expresses the degree of orientation of said optical elements, varying in the direction of film thickness.

As embodiments of the present invention, the optical film wherein said order parameter is expressed as a function of z, S (z), where the thickness direction of the optically anisotropic layer is along z-axis, z varies from 0 to d, both ends inclusive, d is thickness of said optically anisotropic layer; and S(z) is a monotonically increasing function, a monotonically decreasing function, or a mixed function thereof; the optical film wherein the values of S(0), S(d/2) and S(d) are different each other; the optical film wherein said optically anisotropic layer comprises a region in which the optical elements are oriented with an order parameter of 0; an the optical film wherein said order parameter varies within a range from 0 to 0.9, both ends inclusive; are provided.

The optical elements may be selected from discotic or rod-like, liquid-crystalline molecules, or polymer molecules.

The optically anisotropic layer may be formed of a composition comprising a discotic compound and/or a rod-like compound. And the optically anisotropic layer may be formed by applying said composition to a surface.

One embodiment of the present invention is the optical film wherein said optical elements are liquid-crystalline molecules, and said liquid-crystalline molecules are tilted to a layer plane, at an angle varying in the direction of a layer thickness.

Another embodiment of the present invention is the optical film wherein said optically anisotropic layer is formed of a stretched film produced by stretching a polymer film so as to orient said polymer molecules.

The optically anisotropic layer may be produced by stretching a polymer film uniaxially and/or biaxially.

The polymer film may comprise at least one selected from the group consisting of polyamide, polyimide, polyester, polyether-ketone, polyamide-imide, polyester-imide and polyaryl-ether-ketone.

The polymer film may comprise an alicyclic-structure-containing polymer.

The optically anisotropic layer may consist of a single layer or plural layers.

The optical film may further comprise at least a light diffusing layer.

In another aspect, the present invention provides a polarizing plate comprising a polarizing film and two protective films disposed on both surfaces thereof, at least one protective film being an optical film of the present invention; a liquid crystal display device comprising a liquid crystal cell, and at least one polarizing plate, said polarizing plate being a polarizing plate of the present invention; and a liquid crystal display device comprising a liquid crystal cell, at least one polarizing film, and at least one optical film of the present invention disposed between said liquid crystal cell and said polarizing film.

It is to be noted that “parallel” or “orthogonal” described herein in this specification allows a ±5° allowance around the strict angle. Allowance to the strict angle is preferably less than 4°, and more preferably less than 3°. With respect to angle, “+” expresses the clockwise directionality, and “−” expresses the counter-clockwise directionality. “Slow axis” means a direction giving a maximum refractive index. “Visible light region” means a wavelength range from 380 nm to 780 nm. Refractive indices are measured at λ=550 nm in the visible light region unless otherwise specifically noted.

In this patent specification, unless otherwise specifically noted, “polarizing plate” includes both of long polarizing plate, and polarizing plate cut in a size convenient for assembling into the liquid crystal display device (“cut” herein in this patent specification include “punching” and “scissoring”). In this patent specification, “polarizing film” and “polarizing plate” are discriminated from each other, wherein “polarizing plate” means a stack having, on at least on one surface of “polarizing film”, a transparent film protecting the polarizing film.

### BRIEF DESCRIPTION OF THE DRAWINGS

FIG. 1 is a schematic drawing explaining an exemplary configuration of a liquid crystal display device of the present invention;

FIG. 2 is a graph showing distribution of tilt angle of liquid crystal molecules in the liquid crystal display device in the black level display;

FIG. 3 is a schematic drawing explaining a principle of optical compensation in the liquid crystal display device of the present invention;

FIG. 4 is a schematic drawing explaining a principle of optical compensation by a conventional optical film; and

FIG. 5 is a schematic drawing explaining a distribution of order parameter of an optical film in the liquid crystal display device of the present invention.

Symbols in the drawings have the following meanings.

1 polarizing film

2 transmission axis

13 protective film for polarizing film

14 in-plane slow axis

5 optical film

5a average orientation direction of axis of molecular symmetry of discotic compound on the polarizing film side

6 substrate

7 liquid-crystalline molecule

8 substrate

9 optical film

9a average orientation direction of axis of molecular symmetry of discotic compound on the polarizing film side

113 protective film for polarizing film

114 in-plane slow axis

101 polarizing film

102 transmission axis

### DETAILED DESCRIPTION OF THE INVENTION

The present invention will be detailed below.

The present invention relates to an optical film comprising an optically anisotropic layer comprising oriented optical elements, wherein the optical elements are oriented in the optically anisotropic layer with an order parameter varying in the direction of film thickness. The order parameter expresses the degree of orientation of said optical elements. Birefringence An is proportional to order parameter S. This feature of order parameter is detailed, for example, by De Jeu, W. H. in “Ekisho no Bussei (Physical Properties of Liquid Crystal)” (published by Kyoritsu Shuppan Co., Ltd., 1991, p. 40-54). It is therefore made possible to vary birefringence in the direction of thickness by varying the order parameter in the direction of film thickness, and this consequently makes it possible to effectively vary the tilt angle distribution of birefringence of the optical film in the direction of thickness. Using the optical film of the present invention as an optical compensation film of a liquid crystal display device, a good optical compensation can be obtained even when the tilt angle distribution of the optical film does not agree with the tilt angle distribution of liquid crystal molecules in the liquid crystal cell.

Now an explanation will be made on the order parameter. Expression of optical anisotropy needs orientation of the optical elements. The optical elements mentioned herein are elements used in optical engineering causative of refractive index anisotropy, and examples thereof include discotic or rod-like liquid-crystalline molecule showing liquid crystal phase in a predetermined temperature range, or polymer which can be oriented by stretching and so forth. Bulk birefringence of an optical material is varied with the intrinsic birefringence of a single optical element, and with to what degree the optical elements are statistically oriented. For example, magnitude of optical anisotropy of the optically anisotropic layer composed of discotic molecules is determined by the intrinsic birefringence of the discotic compound which is a principal optical element causative of the optical anisotropy, and the degree of statistical orientation of the discotic compound. Order parameter S is a known parameter expressing the degree of orientation. The orientation order parameter has a value of 1 typically for crystal having no distribution, and has a value of “0” for complete randomness such as in liquid state. For example, nematic liquid crystal is generally believed as having a value of 0.6 or around. Order parameter S is detailed for example in De Jeu, W. H. (author), “Ekisho no Bussei (Physical Properties of Liquid Crystal)”, (published by Kyoritsu Shuppan Co., Ltd., 1991, p. 11), and is expressed by the equation below:

$$S = \frac{1}{2} < 3 {cos}^{2} θ - 1 >$$

where, θ is an angle between an average direction of axis of orientation of the oriented elements and the axis of each oriented element.

Known methods of measuring the order parameter include polarized Raman method, IR method, X-ray method, phosphorescence method and sound velocity method. These measurement methods determine orientation distribution functions or orientation coefficients, based on anisotropy in the measured values ascribable to orientation of one element brought into focus. Of the orientation coefficients, the above-described order parameter S is widely used as an index for assessing the orientation state. This is detailed in Kazuro Nakayama and Akira Kaido, “Kobunshi wo Naraberu (Aligning Polymers)” (Kyoritsu Shuppan Co., Ltd., 1991, p. 76-86).

Next, the present invention will be described in detail referring to figures.

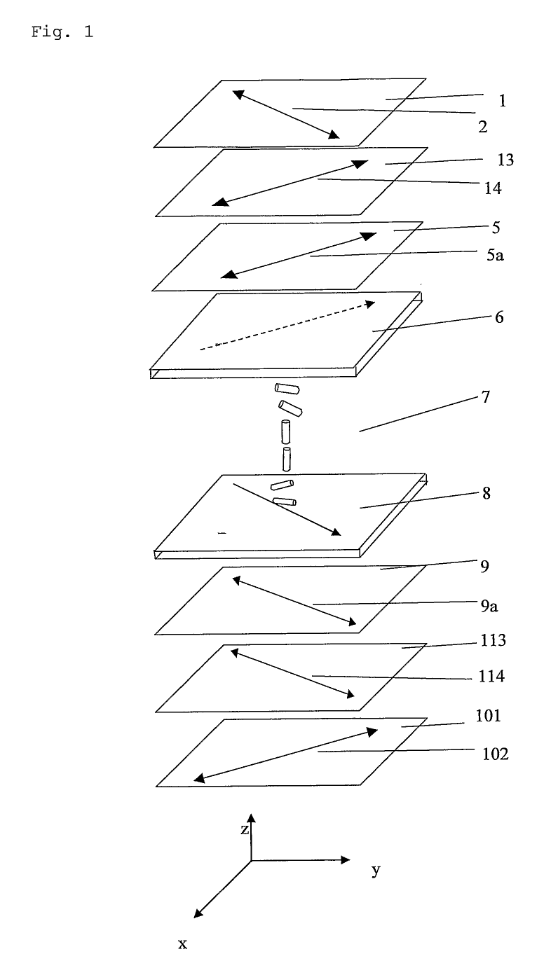

FIG. 1 shows a schematic drawing of an exemplary configuration of a liquid crystal display device of the present invention. The TN-mode liquid crystal display device shown in FIG. 1 comprises a liquid crystal cell which comprises a liquid crystal layer 7 in which a liquid crystal causes electric-field-induced switching under applied voltage, or, in other words, in a black state, and substrates 6, 8 holding the liquid crystal cell in between. The substrates 6, 8 are rubbed on the surfaces thereof facing to the liquid crystal, rubbing direction of which being indicated by arrow RD. The rubbing direction for the rear surface is indicated by a dashed line arrow. Polarizing films 1, 101 are disposed so as to hold the liquid crystal cell in between. Transmission axes 2, 102 of the polarizing films 1, 101 are aligned orthogonal to each other, and at an angle of 90° or 0° to the direction RD on the closer side of the liquid crystal layer 7 of the liquid crystal cell. Between the polarizing film 1, 101 and the liquid crystal cell, there are provided protective films 13, 113 for the polarizing film, and optical films 5, 9, respectively. The protective films 13, 113 are disposed so as to align the slow axes 14, 114 thereof normal to, or in parallel with directions of the transmission axes 2, 102 of the individually adjacent polarizing films 1, 101. The optical films 5, 9 in this embodiment are the optical films according to the present invention, each of which comprising an optically anisotropic layer functionalized by orientation of the discotic molecules.

The liquid crystal cell shown in FIG. 1 comprises the upper substrate 6 and the lower substrate 8, and a liquid crystal layer, held therebetween, composed of liquid crystal molecules 7. Each of the substrates 6, 8 has an alignment film (not shown) formed on the surface thereof facing to the liquid crystal molecules 7 (occasionally referred to as “inner surface”, hereinafter), so as to control the orientation of the liquid crystal molecules 7 aligned in parallel at a pretilt angle. Each of the substrates 6, 8 also has, on the inner surface thereof, a transparent electrode (not shown) applying voltage therethrough to the liquid crystal layer composed of the liquid crystal molecules 7. In the present invention, product Δn·d of thickness of the liquid crystal layer d (μm) and refractive index preferably fall in a range from 0.1 to 1.5 μm, more preferably 0.2 to 1.0 μm, still more preferably 0.2 to 0.5 μm, and further more preferably 0.3 to 0.5 μm. These ranges ensure high luminance in a white state under application of a white state voltage, and consequently provide a bright, high-contrast display device. There are no special limitations on the liquid crystal material to be employed, wherein any liquid crystal material having a positive dielectric anisotropy, causing response of the liquid crystal molecules 7 in parallel with the applied electric field, is used for embodiments in which electric field is applied between the upper and lower substrates 6, 8.

For an exemplary liquid crystal cell configured as a TN-mode liquid crystal cell, it is allowable to use, between the upper and lower substrates 6, 8, a nematic liquid crystal material having a positive dielectric anisotropy, Δn=0.08 and Δε=5 or around. Thickness d of the liquid crystal layer is not specifically limited, but can be set to 4 μm or around for the case where the liquid crystal having properties of the above-described range is employed. Brightness in a white state varies depending on a value of product Δn·d of the thickness d and refractive index anisotropy Δn under application of a white state voltage, so that in view of obtaining a sufficient level of brightness in a white state, it is preferable to set Δn·d of the liquid crystal layer under no applied voltage within a range from 0.3 to 0.5 μm.

The TN-mode liquid crystal display device may sometimes be added with a chiral agent in order to reduce orientation failure. The TN-mode display may sometimes be configured as having a multi-domain structure. The multi-domain structure refers to a structure in which a single pixel of the liquid crystal display device is divided into a plurality of domains. Adoption of the multi-domain structure to the TN-mode device is preferable in view of improving the viewing-angle-related characteristics of luminance and color tone. More specifically, averaging through configuration of each pixel with two or more (preferably 4 or 8) domains, differing from each other in the initial orientation state of the liquid crystal molecules, makes it possible to reduce viewing-angle-dependent non-uniformity in the luminance and color tone. Similar effect can be obtained also by configuring each pixel using two or more domains differing from each other, in which direction of orientation of the liquid crystal molecules can continuously vary under voltage application.

The protective films 13, 113 for the polarizing films 1, 101, respectively, may also function as supports for the optical films 5, 9. The optical films 5, 9 functionalized also as the protective films for the polarizing films make it possible to dispense with the protective films 13, 113. The polarizing film 1, the protective film 13 and the optical film 5; or the polarizing film 101, the protective film 113 and the optical film 9 may form an integrated stack and may be incorporated into the liquid crystal display device, or may respectively be incorporated as a separate component. It is preferable that the slow axis 14 of the protective film 13 and the slow axis 114 of the protective film 113 are substantially in parallel with, or cross orthogonally to each other. The orthogonal arrangement of the slow axes 14, 114 of the protective films 13, 113 makes it possible to reduce degradation of optical characteristics of light normally incident on the liquid crystal display device, because birefringent properties of both optical films are canceled. The parallel arrangement of the slow axes 14, 114 makes it possible to compensate any residual retardation of the liquid crystal layer, using the birefringent properties of these protective films. It is still also allowable that the protective films 13, 113 have no in-plane slow axes 14, 114.

Directions of the transmission axes 2, 102 of the polarizing films 1, 101, slow axes 14, 114 of the protective films 13, 113, and orientation of the liquid crystal molecules 7 can be adjusted within optimum ranges depending on materials used for composing the individual components, display mode and stacked structure of the components. That is, the transmission axis 2 of the polarizing film 1 and the transmission axis 102 of the polarizing film 101 are disposed so as to cross substantially normal to each other. The liquid crystal display device of the present invention is, however, not limited to this configuration.

The optical films 5, 9 are respectively disposed between the polarizing films 1, 101 and the liquid crystal cell. Each of the optical films 5, 9 is typically an optically anisotropic layer composed of a compound containing a discotic compound. In the optical films 5, 9, molecules of the discotic compound are fixed to a predetermined orientation state. The optical films 5, 9 have in-plane optical anisotropy, wherein the optical anisotropy is produced by orientation of the optical elements in the film, or the discotic compound molecules, with the order parameter which expresses the degree of orientation of the optical elements varied in the direction of film thickness. This configuration makes it possible to ensure a sufficient level of optical compensation function of the optical films, in a manner corresponding to the orientation distribution of the liquid crystal layer 7, which is non-uniform in the thickness-wise direction.

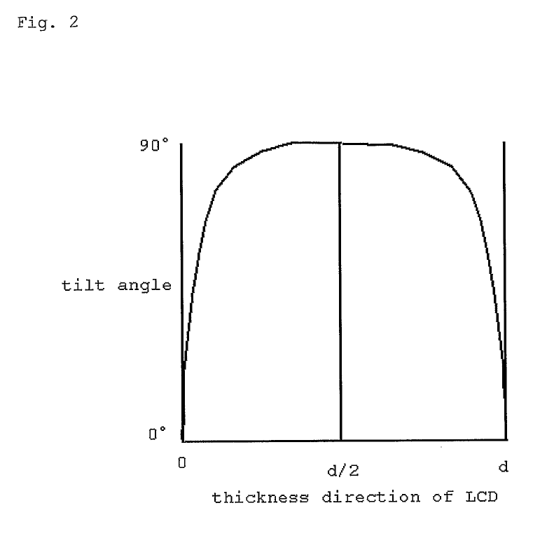

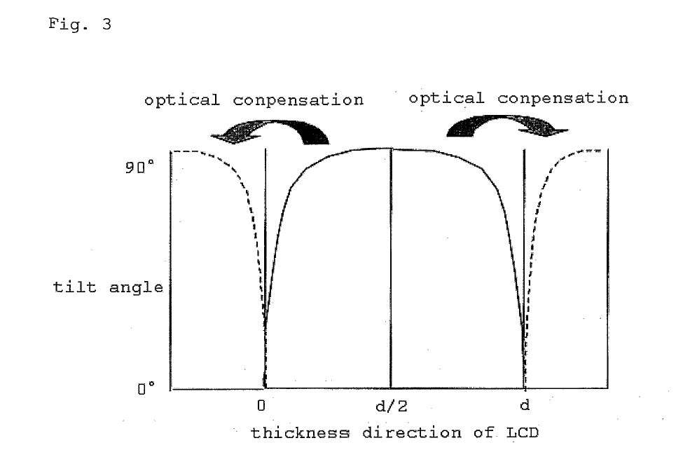

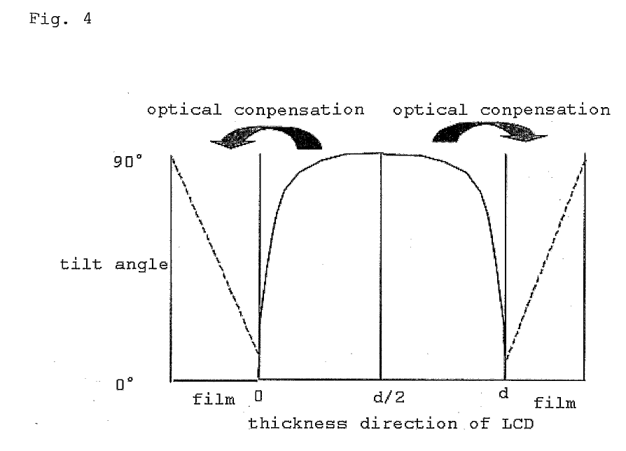

In an operational state under application of a black state voltage to the individual transparent electrodes (not shown) of the liquid crystal cell substrates 6, 8, the liquid crystal molecules 7 in the liquid crystal layer, kept in the TN state uniformly tilted by 90° or around, rise up in the direction of electric field at around the center of the cell, and abruptly lie down almost horizontally to the surface of the cell substrate, showing an upwardly convex distribution of the tilt angle of the liquid crystal molecules. FIG. 2 shows the distribution of the tilt angle of the liquid crystal molecules 7 in the liquid crystal cell of the liquid crystal display device (LCD) under an operation state. It is preferable that also the optical films having optical compensation function in a black state have a tilt angle distribution corresponded to such tilt angle distribution of the liquid crystal molecules in the cell. FIG. 3 shows a tilt angle distribution of the optical films required for ideally compensating the liquid crystal cell disposed as being held in between, together with the tilt angle distribution of the liquid crystal molecules in the liquid crystal cell. In practice, it is difficult to produce the optical films having such tilt angle distribution and consequently having such optical anisotropy distribution, and a conventional film used for optical compensation has, as shown in FIG. 4, a distribution of tilt angle different from that of the liquid crystal cell.

This embodiment of the present invention, based on the order parameter of the optical films 5, 9 varied in the thickness-wise direction, makes it possible to provide optical compensation corresponded to the tilt angle distribution of the liquid crystal molecules, even when the optical films 5, 9 do not have a tilt angle distribution identical to that of the liquid crystal cell as shown in FIG. 4.

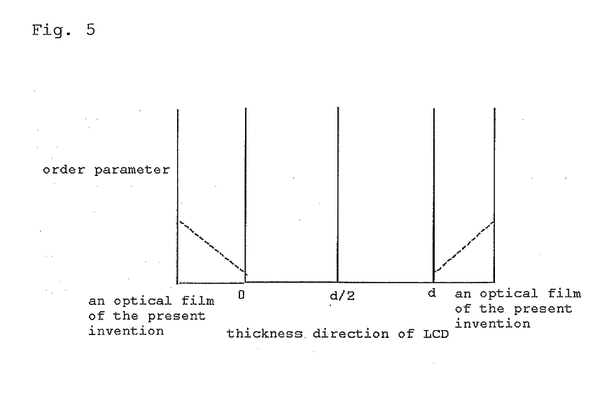

The optical films 5, 9 have, as shown in FIG. 5, the order parameter varying in the thickness-wise direction. The variation in the order parameter corresponds with the slope of a function of the tilt angle of the liquid crystal molecules 7 in the liquid crystal cell. More specifically, the order parameter of the orientation of the discotic molecules in the optical film, which contribute to the optical compensation of the liquid crystal molecules in the cell aligned at a tilt angle varying with a large slope, or, in other words, the liquid crystal molecules in a region where the tilt angle abruptly changes, is adjusted to a small value, and consequently the birefringence is suppressed to a small value. On the other hand, the order parameter of the orientation of the discotic molecules in the optical film, which contribute to the optical compensation of the liquid crystal molecules in the cell aligned at a tilt angle varying with a small slope, or, in other words, liquid crystal molecules in a region where changes in the tilt angle are small, is adjusted to a large value, and consequently the birefringence is increased. In other words, the optical films 5, 9 have a birefringence not constant in the thickness-wise direction, and exhibit a distribution of birefringence corresponded to the distribution of tilt angle of the liquid crystal molecules in the liquid crystal cell. The optical films 5, 9, having the distribution of order parameter as shown in FIG. 5, can achieve an effective profile of tilt angle similar to that shown in FIG. 3, even if the tilt angle distribution thereof does not agree with that of the liquid crystalline molecules 7 in the liquid crystal cell as shown in FIG. 4, and therefore make it possible to obtain effects similar to those shown in FIG. 3, and to provide a desired optical compensation.

The above description has been made on an embodiment in which the optical film of the present invention was applied to optical compensation of a TN-mode liquid crystal display device, whereas the optical film of the present invention is also applicable to optical compensation of liquid crystal display devices based on other modes. By developing a distribution of the order parameter with respect to orientation of the optical elements in the optically anisotropic layer, depending on thickness-wise distribution of tilt angle of the liquid crystal molecules in liquid crystal cell, which is a target for optical compensation, and distribution of birefringence required for such optical compensation, it is made possible to produce the optical film applicable to optical compensation of liquid crystal devices of any modes. The above-described embodiment showed an exemplary case of using two optical films for optical compensation, whereas the number of the optical film of the present invention may be one, or three or more.

In the optical film of the present invention, there are no special limitations on modes of change in the order parameter, allowing both of continuous change and intermittent change. Combinations of these changes are also allowable. The optical films, employing a combination of a continuous change and a intermittent change, may be produced by stacking a layer having a continuous change in the order parameter and a layer having the order parameter kept constant. Assuming now that the order parameter S is expressing as a function of z, S(z), where the thickness direction of the optically anisotropic layer is along z-axis in FIG. 1, z varies from 0 to d, both ends inclusive (0≦z≦d), d is thickness of said optically anisotropic layer; any embodiments in which S (z) is a monotonically increasing function, a monotonically decreasing function or a mixed function thereof falls within the scope of the present invention. In particular, for the purpose of optical compensation of TN-mode liquid crystal display devices, S(z) is preferably any one of a monotonically increasing function, monotonically decreasing function, and mixed function thereof. The mode of change in the order parameter may be intermittent as described in the above, wherein it is preferable that at least three values of S(0), S(d/2) and S(d) differ from each other.

The optically anisotropic layer may include a region in which the order parameter has a value of approximately 0. Approximately 0 means that the order parameter is almost 0, and more specifically that the order parameter falls in a range from 0 to 0.1, both ends inclusive. The order parameter of approximately 0 means a state almost free from retardation, and is almost isotropic in terms of optical engineering. There are no special limitations on the upper and lower limits of the order parameter, allowing variation within a predetermined range depending on purpose of use. For optical compensation of TN-mode liquid crystal display devices, the order parameter preferably ranges from 0 to 0.9, both ends inclusive, and more preferably from 0 to 0.8.

The order parameter can be controlled by adopting various methods selected depending on types of the optical elements used for producing the optically anisotropic layer. Examples of the methods include a method of varying ratio of stretching in uniaxial stretching, a method of varying ratio of stretching in biaxial stretching, a method using gel stretching, a method using single crystal mat, a method of using polymerizable powder, a method based on orientation crystallization, a method based on fusion stretching, a method based on rolling, a method based on solid extrusion under control of temperature and pressure, a method based on drawing, a method making use of fluidization of liquid-crystalline polymer, a method of producing orientation structure by injection molding, a method of altering orientation structure by external fields, a method of controlling degree of orientation by temperature, and a method of controlling degree of orientation by temperature gradient. The order parameter can be varied in the direction of thickness, by varying conditions for controlling the orientation in the direction of film thickness by any of these methods. The orientation control is detailed in Kazuro Nakayama and Akira Kaido, “Kobunshi wo Naraberu (Aligning Polymers)” (Kyoritsu Shuppan Co., Ltd., 1991, p. 9-75).

Next, materials and so forth used for producing the optical film of the present invention will be described in detail.

The optical film of the present invention has an optically anisotropic layer formed by orienting the optical elements. The optical elements composing the optically anisotropic layer are elements used in optical engineering causative of refractive index anisotropy as described in the above, and is exemplified by discotic or rod-like, liquid-crystalline molecules showing a liquid crystal phase in a predetermined temperature range, and polymers which can be oriented by stretching and so forth. For the case where the optical elements are liquid-crystalline molecules, the optically anisotropic layer can be formed using a composition comprising a discotic compound, or using a composition comprising a rod-like compound. The above-described optically anisotropic layer can be formed by applying the composition on the surface of a support or an alignment film, and allowing the discotic molecules or rod-like molecules to orient under predetermined conditions, and then fixing the desired orientation state. For the case where the optical elements are polymer molecules, the optically anisotropic layer can be formed by stretching a polymer film under predetermined conditions. The optical film of the present invention may comprise a plurality of the above-described optically anisotropic layers, or may comprise only a single optically anisotropic layer. For example, the optical film may comprise only the optically anisotropic layer having the discotic or rod-like liquid-crystalline molecules as the optical elements, or may comprise only a stretched polymer film having polymer molecules as the optical elements. It is also allowable to stack two or more optically anisotropic layers selected from the above. The optical film of the present invention may still also have a layer other than the optically anisotropic layer, and may typically comprise the optically anisotropic layer having the discotic or rod-like, liquid-crystalline molecules as the optical elements, and a polymer film as a support of the optically anisotropic layer. The optical film may further have a functional layer such as a light diffusing layer described later, depending on purposes of use. The optically anisotropic layer may comprise a plurality of layers, and may typically be a stack composed of an optically anisotropic layer having the order parameter varied in the thickness-wise direction thereof, and an optically anisotropic layer having the order parameter kept unchanged.

The optical film of the present invention preferably contains any of discotic liquid-crystalline compounds listed below in the optically anisotropic layer thereof. The optically anisotropic layer can be formed by orienting liquid-crystalline molecules using an alignment film, and by fixing the resultant orientation state. The liquid-crystalline molecules preferably have polymerizable groups in order to fix the orientation state of the liquid-crystalline molecules.

### (Discotic Liquid-Crystalline Compound)

Discotic liquid-crystalline compounds include benzene derivatives described in C. Destrade et al., Mol. Cryst., Vol. 171, p. 111 (1981); torxene derivatives described in C. Destrade et al., Mol. Cryst., Vol. 122, p. 141 (1985) and Physics Lett., A, Vol. 78, p. 82 (1990); cyclohexane derivatives described in B. Kohne et al., Angew. Chem., Vol. 96, p. 70 (1984); and azacrown-base or phenylacetylene-base macrocycles described in J. M. Lehn, J. Chem. Commun., p. 1794 (1985) and in J. Zhang et al., J. Am. Chem. Soc., Vol. 116, p. 2655 (1994).

The above-described discotic liquid-crystalline compounds also include liquid-crystalline compounds having structures in which the individual cores at the center of molecules are radially substituted by side chains such as straight-chain alkyl group, alkoxy group of substituted benzoyloxy group. The molecules or molecular aggregates preferably have rotation symmetry, and such as those possibly given with a certain orientation.

As described in the above, for the case where the optically anisotropic layer is formed using the liquid-crystalline compound, it is no more necessary for the compound finally contained in the optically anisotropic layer to exhibit liquid crystal property. In an exemplary case where a low-molecular-weight discotic liquid-crystalline compound has a heat- or photo-reactive group, and the optically anisotropic layer is formed by conversion of the compound into high-molecular-weight one, through polymerization or crosslinking caused by reaction of the group induced by heat or light, the compound contained in the optically anisotropic layer may have lost its liquid crystal property. Preferable examples of the discotic liquid-crystalline compounds are descried in Japanese Laid-Open Patent Publication “Tokkaihei” No. 8-50206. Polymerization of the discotic liquid-crystalline compounds is described in Japanese Laid-Open Patent Publication “Tokkaihei” No. 8-27284.

In order to fix the discotic liquid-crystalline compounds through polymerization, it is necessary to bind a discotic core of the discotic liquid-crystalline compound with polymerizable groups as substituent groups. Direct bonding of the polymerizable groups to the discotic core, however, makes it difficult to keep a desired orientation state during the polymerization reaction. A coupling group is therefore introduced between the discotic core and each of the polymerizable groups. The discotic liquid-crystalline compounds having the polymerizable groups are, therefore, preferably such as those expressed by the formula (III) below:

D(-L-Q)ₙ Formula (III)

where, D represents a discotic core, L represents a divalent coupling group, Q represents a polymerizable group, and n represents an integer from 4 to 12.

Examples of the discotic core (D) are shown below. In each of the examples below, LQ (or QL) means combinations of the divalent coupling group (L) and the polymerizable group (Q).

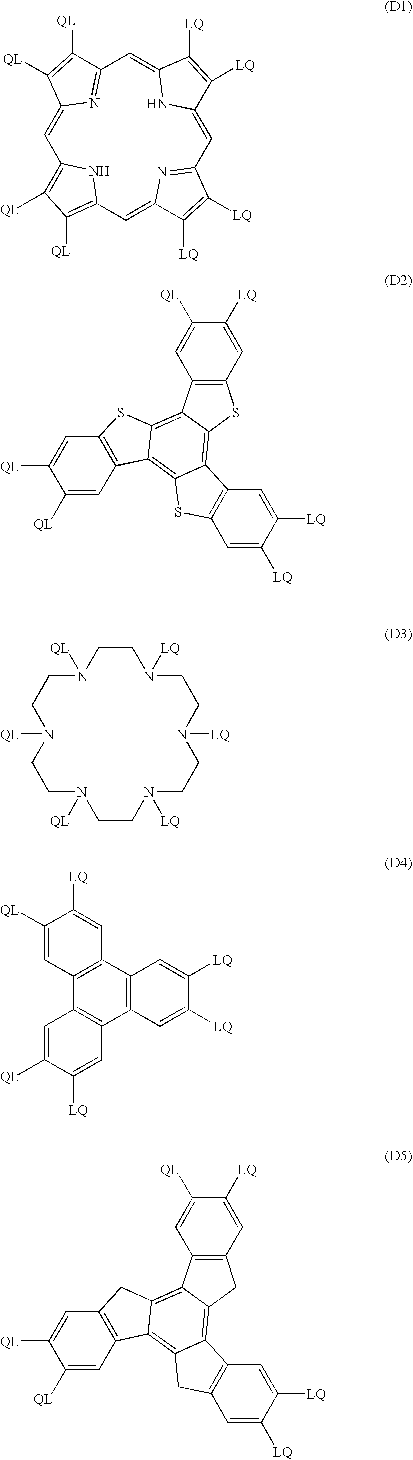

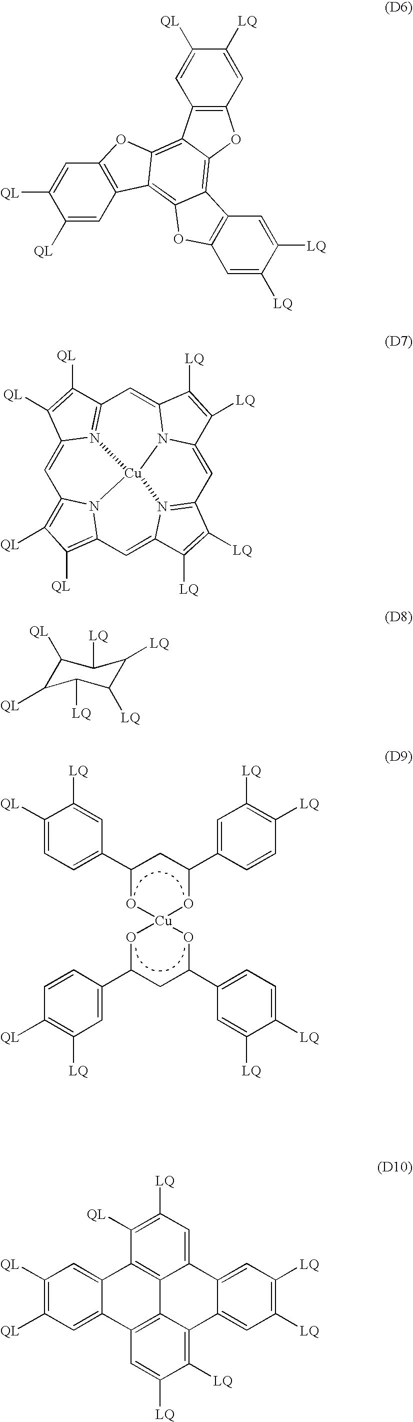

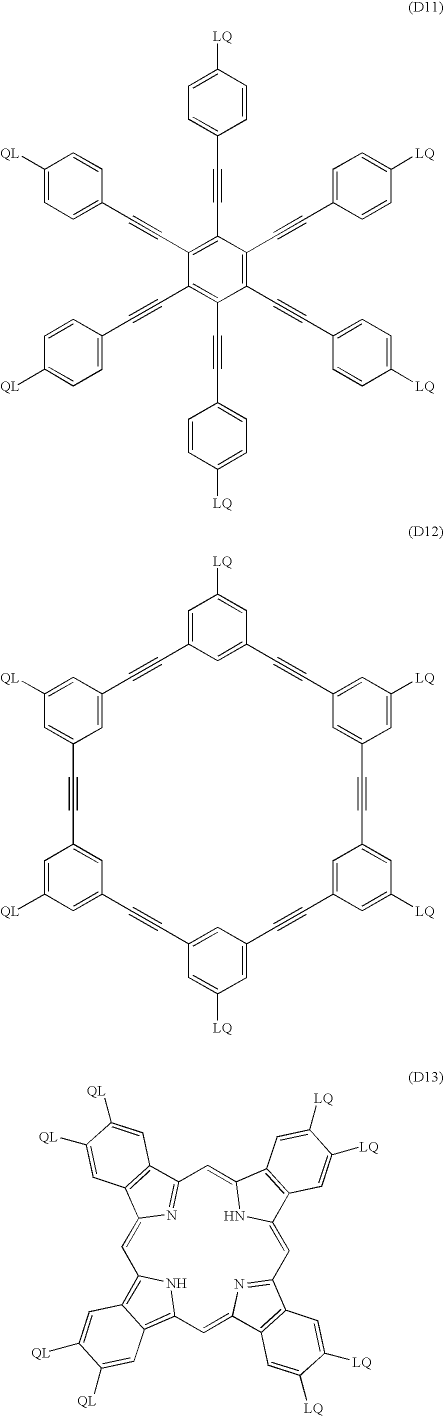

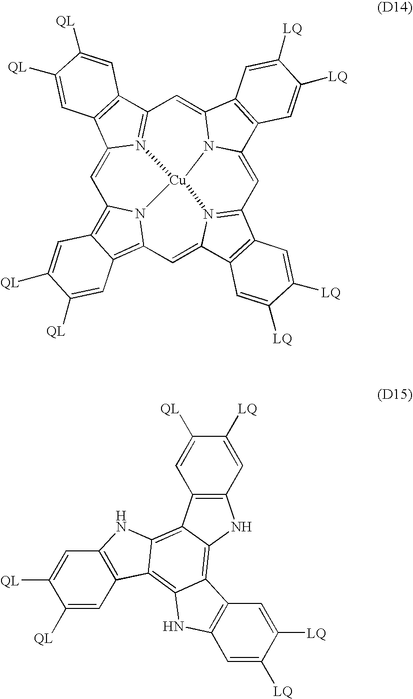

In formula (III), the divalent coupling group (L) is preferably any one of those selected from the group consisting of alkylene group, alkenylene group, arylene group, —CO—, —NH—, —O—, —S— and combinations of these groups. The divalent coupling group (L) is more preferably based on combination of at least two divalent groups selected from the group consisting of alkylene group, arylene group, —CO—, —NH—, —O— and S—. The divalent coupling group (L) is most preferably based on combination of at least two divalent groups selected from the group consisting of alkylene group, arylene group, —CO— and O—. The number of carbon atoms of the alkylene group is preferably 1 to 12. The number of carbon atoms of the alkenylene group is preferably 2 to 12. The number of carbon atoms of the arylene group is preferably 6 to 10.

Examples of the divalent coupling group (L) are listed below. The left end binds with the discotic core (D), and the right end binds with the polymerizable group (Q). AL represents an alkylene group or an alkenylene group, and AR represents an arylene group. The alkylene group, alkenylene group and arylene group may have a substituent (e.g., alkyl group).
L1: -AL-CO—O-AL-
L2: -AL-CO—O-AL-O—
L3: -AL-CO—O-AL-O-AL-
L4: -AL-CO—O-AL-O—CO—
L5: —CO-AR—O-AL-
L6: —CO-AR-O-AL-O—
L7: —CO-AR-O-AL-O—CO—
L8: —CO—NH-AL-
L9: —NH-AL-O—
L10: —NH-AL-O—CO—
L11: —O-AL-
L12: —O-AL-O—
L13: —O-AL-O—CO—
L14: —O-AL-O—CO—NH-AL-
L15: —O-AL-S-AL-
L16: —O—CO-AR—O-AL-CO—
L17: —O—CO-AR—O-AL-O—CO—
L18: —O—CO-AR—O-AL-O-AL-O—CO—
L19: —O—CO-AR—O-AL-O-AL-O-AL-O—CO—
L20: —S-AL-
L21: —S-AL-O—
L22: —S-AL-O—CO—
L23: —S-AL-S-AL-
L24: —S-AR-AL-

The polymerizable group (Q) in formula (III) is determined depending on types of the polymerization reaction. The polymerizable group (Q) is preferably an unsaturated polymerizable group of an epoxy group, more preferably an unsaturated polymerizable group, and most preferably an ethylenic unsaturated polymerizable group.

In formula (III), n is an integer from 4 to 12. Specific value of n is determined depending on types of the discotic core (D). A plurality of combinations of L and Q may differ, but are preferably the same.

### (Rod-Like Liquid-Crystalline Compound)

Examples of the rod-like liquid-crystalline compound applicable to the present invention include azomethine compounds, azoxy compounds, cyanobiphenyl compounds, cyanobiphenyl compounds, cyanophenyl esters, benzoate esters, cyclohexanecarboxylic acid phenyl esters, cyanophenylcyclohexane compounds, cyano-substituted phenylpyrimidine compounds, alkoxy-substituted phenylpyrimidine compounds, phenyldioxane compounds, tolan compounds and alkenylcyclohexylbenzonitrile compounds. Not only the low-molecular-weight, liquid-crystalline compound as listed in the above, high-molecular-weight, liquid-crystalline compound may also be applicable.

The rod-like liquid-crystalline molecule preferably has a polymerizable group so as to be fixed through polymerization reaction. Examples of the polymerizable rod-like liquid-crystalline compound applicable to the present invention include compounds described for example in Makromol. Chem., 190, p. 2255 (1989), Advanced Materials, 5, p. 107 (1993), U.S. Pat. No. 4,683,327, ditto U.S. Pat. No. 5,622,648, ditto U.S. Pat. No. 5,770,107, International Patent (WO) No. 95/22586, ditto No. 95/24455, ditto No. 97/00600, ditto No. 98/23580, ditto No. 98/52905, Japanese Laid-Open Patent Publication “Tokkaihei” No. 1-272551, ditto No. 6-16616, ditto No. 7-110469, ditto No. 11-80081, and Japanese Laid-Open Patent Publication “Tokkai” No. 2001-328973.

### (Optically Anisotropic Layer Comprising Discotic Liquid-Crystalline Molecules or Rod-like Liquid-Crystalline Molecules)

In the optically anisotropic layers, the molecules of the rod-like compound or the discotic compound are preferably fixed in an oriented state. Average orientation direction of the axes of symmetry of the liquid-crystalline compound molecules at the interfaces with the optical films crosses at an angle of approximately 45° to the in-plane slow axes of the optical films. It is to be noted herein that “approximately 45° ” means a range of 45°±5°, preferably from 42 to 48°, and more preferably from 43 to 47°. The average orientation direction of the axes of symmetry of the liquid-crystalline compound molecules in the optically anisotropic layers preferably falls within a range from 43° to 47° to the longitudinal direction of the support (i.e., the direction of fast axis of the support).

The average orientation direction of the axes of symmetry of the liquid-crystalline compound molecules can generally be adjusted by selecting liquid-crystalline compound or materials composing the alignment film, or by selecting method of rubbing. In an exemplary case of the present invention where the alignment film forming the optically anisotropic layer is produced by rubbing, rubbing in a 45° direction to the slow axis of a polymer film composing the support makes it possible to produce the optically anisotropic layer having an average orientation direction, at least at the interface with the polymer film, of 45° to the slow axis of the polymer film. For example, the optically anisotropic layer can continuously be produced by using a long polymer film having the slow axis in parallel with the longitudinal direction thereof. More specifically, a coating liquid for forming the alignment film is continuously coated on the surface of a long polymer film, the surface of the coated film is then continuously rubbed in the direction 45° to the longitudinal direction to thereby form the alignment film, a coating liquid for forming the optically anisotropic layer containing the liquid-crystalline compound is then continuously coated on the surface of thus-formed alignment film, so as to orient the liquid-crystalline compound molecules and to fix the orientation state, to thereby form the long optically anisotropic layer, and to consequently produce the long optical film in a continuous manner. Thus-produced long optical film is cut into a desired geometry before being incorporated into the liquid crystal display device.

The average orientation direction of the axes of symmetry of the liquid-crystalline compound molecules on the air interface side can generally be adjusted by selecting species of the liquid-crystalline compound or any additives used in combination with the liquid-crystalline compound. Examples of the additives used in combination with the liquid-crystalline compound include plasticizer, surfactant, polymerizable monomer and polymer. Also the degree of change in the orientation direction of the axes of molecular symmetry can be adjusted by selecting the liquid-crystalline compound and the additives, similarly to as described in the above. In particular, the surfactant is preferably selected taking a balance with control of surface tension of the above-described coating liquid into consideration.

The plasticizer, surfactant and polymerizable monomer used in combination with the liquid-crystalline compound are preferably such as being compatible with the discotic liquid-crystalline compound, and as being causative of changes in the tilt angle of the liquid-crystalline compound molecules, or as being not inhibitory to the orientation. Of these, polymerizable monomer (e.g., compounds having vinyl group, vinyloxy group, acryloyl group or methacryloyl group) is preferable. Amount of addition of the above-described compounds generally falls in a range from 1 to 50% by mass of the liquid-crystalline compound, and more preferably 5 to 30% by mass. A mixed use of a monomer having four or more polymerizable, reactive functional groups makes it possible to enhance adhesiveness between the alignment film and the optically anisotropic layer.

For the case where the discotic liquid-crystalline compound is used as the liquid-crystalline compound, it is preferable to use a polymer having a certain level of compatibility with the discotic liquid-crystalline compound, and capable of changing the tilt angle of the discotic liquid-crystalline compound.

The polymer is exemplified by cellulose ester. Preferable examples of the cellulose ester include cellulose acetate, cellulose acetate propionate, hydroxypropyl cellose and cellulose acetate butylate. Amount of addition of the polymer is preferably adjusted within a range from 0.1 to 10% by mass of the discotic liquid-crystalline compound so as not to inhibit orientation thereof, more preferably from 0.1 to 8% by mass, and still more preferably from 0.1 to 5% by mass.

Transition temperature from nematic liquid crystal phase to solid phase of the discotic liquid-crystalline compound preferably falls within a range from 70 to 300° C., and more preferably 70 to 170° C.

### (Alignment Film)

The optical film of the present invention may be produced using an alignment film when the optically anisotropic layer thereof is formed. In an exemplary case where the optically anisotropic layer is formed using a composition containing the liquid-crystalline compound, it is a general practice to form it on a support, wherein it is preferable to form the alignment film on the surface of the support, and then to form thereon the optically anisotropic layer. It is also allowable to use the alignment film only when the optically anisotropic layer is formed, and to transfer only the optically anisotropic layer, after being formed on the alignment film, onto the support composed of a polymer film or the like. The alignment film is preferably a layer composed of a crosslinked polymer. The polymer used for the alignment film may be those spontaneously crosslinkable by themselves, or may be those crosslinkable with the aid of a crosslinking agent. Of course polymer having both functions are applicable. The alignment film can be formed by allowing the polymer molecules having functional groups, intrinsically residing therein or being introduced later, to react with each other with the aid of heat, pH change or the like; or by allowing a crosslinking agent, which is a highly reactive compound, to react with the polymers so as to introduce a coupling group derived therefrom between the polymer molecules, to thereby crosslink the polymer.

The orientation composed of the crosslinked polymer can generally be formed by coating a coating liquid containing such polymer, or a mixture containing such polymer and a crosslinking agent, on the surface of a support, and then by heating the coated film.

It is preferable herein to raise the degree of crosslinkage in view of suppressing dust generation in the rubbing described later. Defining now that the degree of crosslinkage as a value (1-(Ma/Mb)), which is a ratio (Ma/Mb) subtracted by 1, where (Ma/Mb) being a ratio of amount of crosslinking agent added to the coating liquid (Mb) and amount of crosslinking agent remaining therein after crosslinking (Ma), the degree of crosslinkage is preferably 50% to 100%, more preferably 65% to 100%, and most preferably 75% to 100%.

The polymers applicable to the alignment film may be those spontaneously crosslinkable by themselves, or may be those crosslinkable with the aid of a crosslinking agent. Of course polymer having both functions are applicable. Examples of the polymer include polymethyl methacrylate, acrylic acid/methacrylic acid copolymer, styrene/maleimide copolymer, polyvinyl alcohol and modified polyvinyl alcohol, poly(N-methylolacrylamide), styrene/vinyltoluene copolymer, chlorosulfonated polyethylene, nitrocellulose, polyvinyl chloride, chlorinated polyolefin, polyester, polyimide, vinyl acetate/vinyl chloride copolymer, ethylene/vinyl acetate copolymer, carboxymethyl cellulose, gelatin, polyethylene, polypropylene and polycarbonate, and silane coupling agent. Examples of the preferable polymer include water-soluble polymers such as poly(N-methylolacrylamide), carboxymethyl cellulose, gelatin, polyvinyl alcohol and modified polyvinyl alcohol, of these further preferable are gelatin, polyvinyl alcohol and modified polyvinyl alcohol, and particularly preferable are polyvinyl alcohol and modified polyvinyl alcohol.

Known polyvinyl alcohol typically has a degree of saponification of 70 to 100%, wherein those having a degree of saponification of 80 to 100% are generally preferred, and those having a degree of saponification of 82 to 98% are more prefereed. The degree of polymerization is preferably within a range from 100 to 3000.

The modified polyvinyl alcohol can be exemplified by those modified by copolymerization (having COONa, Si(OX)₃, N(CH₃)₃.Cl, C₉H₁₉COO, SO₃Na or C₁₂H₂₅, for example, incorporated therein as a modifying group), those modified by chain transfer (having COONa, SH or SC₁₂H₂₅, for example, incorporated therein as a modifying group), and those modified by block polymerization (having COOH, CONH₂, COOR or C₆H₅, for example, incorporated there in as a modifying group). The degree of polymerization is preferably within a range from 100 to 3000. Of these, preferable is an unmodified or modified polyvinyl alcohol having a degree of saponification of 80 to 100%, and more preferable is an unmodified or alkylthio-modified having a degree of saponification of 85 to 95%.

The modified polyvinyl alcohol used for the alignment film is preferably a reaction product of a compound expressed by the formula (6) below and polyvinyl alcohol:

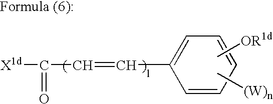

where, R^{1d} represents a non-substituted alkyl group, or an alkyl group substituted by an acryloyl group, methacryloyl group or epoxy group, W represents a halogen atom, alkyl group or alkoxy group, X^{1d} represents an atomic group necessary for forming an active ester, acid anhydride or acid halide, 1 represents 0 or 1, and n represents an integer from 0 to 4.

A reaction product of a compound expressed by formula (7) below and polyvinyl alcohol is also preferable as the modified polyvinyl alcohol used for the alignment film:

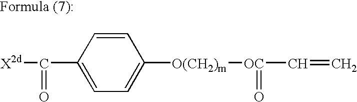

where X^{2d} represents an atomic group necessary for forming an active ester, acid anhydride or acid halide, and m represents an integer from 2 to 24.

Examples of polyvinyl alcohol reacted with the compounds expressed by the formulae (6) and (7) include unmodified polyvinyl alcohol, and copolymerization-modified polyvinyl alcohol such as being modified by chain transfer or by block polymerization. Preferable examples of the above-described specific modified polyvinyl alcohol are detailed in Japanese Laid-Open Patent Publication “Tokkaihei” No. 8-338913.

For the case where a hydrophilic polymer such as polyvinyl alcohol is used for the alignment film, it is preferable, in view of hardness of the film, to control moisture content, which is preferably adjusted to 0.4% to 2.5%, and more preferably adjusted to 0.6% to 1.6%. The moisture content can be measured using a commercial Karl-Fischer moisture titrator.

The alignment film is preferably has a thickness of 10 μm or thinner.

### (Optically Anisotropic Layer Composed of Polymer Film)

As described in the above, the optically anisotropic layer may be formed of a polymer film. The polymer film is formed using a polymer capable of exhibiting optical anisotropy. Examples of such polymer include polyolefins (e.g., polyethylene, polypropylene, norbornene-base polymers), polycarbonate, polyarylate, polysulfone, polyvinyl alcohol, polymethacrylate ester, polyacrylate ester, and cellulose ester (e.g., cellulose triactate, cellulose diacetate). It is also allowable to use copolymers or mixtures of these polymers.

The optical anisotropy of the polymer film is preferably obtained by stretching. The stretching is preferably uniaxial stretching, biaxial stretching or combination of the both. More specifically, preferable examples include longitudinal uniaxial stretching making use of difference in peripheral speeds of two or more rollers, tenter stretching effecting width-wise stretching of a polymer film while being held at both edges thereof, and biaxial stretching based on combination of these methods. It is also allowable to use two or more polymer films, so that optical characteristics of two or more films as a whole can satisfy the above-described conditions. The polymer film is preferably produced by the solvent cast process in view of reducing non-uniformity in birefringence. Thickness of the polymer film is preferably 20 to 500 μm, and more preferably 40 to 100 μm.

Another method of producing the polymer film forming the optically anisotropic layer, preferably applicable herein, is such as using at least one polymer material selected from the group consisting of polyamide, polyimide, polyester, polyether-ketone, polyamide-imide-polyester-imide and polyaryl-ether-ketone, coating on a base a solution prepared by dissolving such polymer material into a solvent, and allowing the solvent to evaporate so as to leave a film. A technique preferably employed in this process is such as stretching the polymer film and the base so as to produce optical anisotropy, and using them as the optically anisotropic layer, wherein a cellulose acylate film of the present invention can preferably be used as the base. It is also preferable that the polymer film is preliminarily produced on a separate base, the polymer film is then peeled off from the base and placed on the cellulose acylate film, so that these are used together as the optically anisotropic layer. This technique is successful in thinning the polymer film, the thickness of which is preferably 50 μm or less, and more preferably from 1 to 20 μm.

### (Alicyclic-Structure-Containing Polymer)

The polymer film preferably contains an alicyclic-structure-containing polymer. The alicyclic-structure-containing polymer is a compound having an alicyclic structure in a repetitive unit of the polymer, wherein the alicyclic structure may be contained in either of the principal chain and the side chain. The alicyclic structure can be exemplified by cycloalkane structure and cycloalkene structure, wherein the cycloalkane structure is preferable in view of heat stability. The number of carbon atoms composing the alicyclic structure is generally 4 to 30, preferably 5 to 20, and more preferably 5 to 15. The number of carbon atoms composing the alicyclic structure kept within the above-described ranges makes it possible to obtain a protective layer excellent in heat resistance and flexibility. Ratio of the repetitive unit having the alicyclic structure in the alicyclic-structure-containing polymer may appropriately be selected depending on the purpose of use, generally 50% by mass or more, preferably 70% by mass or more, and more preferably 90% by mass or more. An extremely small ratio of the repetitive unit having the alicyclic structure results in a lowered heat resistance, and is undesirable. Any repetitive units other than the repetitive unit having the alicyclic structure in the alicyclic-structure-containing polymer can appropriately be selected depending of purpose of use.

Specific examples of the alicyclic-structure-containing polymer include (1) norbornene-base polymer, (2) monocyclic olefin polymer, (3) cyclic conjugate diene polymer, (4) vinyl alicyclic hydrocarbon polymer, and hydride of polymers (1) to (4). Of these, norbornene-base polymer hydride, vinyl alicyclic hydrocarbon polymer and its hydride are preferable in view of heat resistance, mechanical strength and so forth.

The norbornene-base polymer refers to polymerized products of monomers mainly comprising norbornene-base monomers such as norbornene and its derivatives, tetracyclododecene and its derivatives, dicyclopentadiene and its derivatives, and methanotetrahydrofluorene and its derivatives, and specific examples include ring-opened polymer of norbornene-base monomers, ring-opened polymer of norbornene-base monomers and any other monomers copolymerizable therewith by ring-opening reaction, addition polymer of norbornene-base monomers, and addition copolymer of norbornene-base monomers and any other monomers copolymerizable therewith. Of these, hydride of ring-opened polymer of norbornene-base monomers is most preferable. Molecular weight of the norbornene-base polymer, monocyclic olefin polymer or cyclic conjugate diene polymer may appropriately be selected depending on purpose of use, wherein mechanical strength and moldability of the optical film can excellently be balanced, if the polyisoprene- or polystyrene-equivalent weight average molecular weight, measured in a form of cyclohexane solution (toluene solution for insoluble polymer) by gel permeation chromatography, is generally adjusted to a range from 5,000 to 500,000, preferably from 8,000 to 200,000, and more preferably from 10,000 to 100,000. The vinyl alicyclic hydrocarbon polymer refers to polymers having repetitive units derived from vinyl cycloalkane or vinyl cycloalkene, and applicable examples include vinyl-group-containing cycloalkane and vinyl-group-containing cycloalkene such as vinyl cyclohexene and vinyl cyclohexane, or in other words, polymers of vinyl alicyclic hydrocarbon compound and its hydrides; and hydrides of aromatic group portion of polymers of vinyl aromatic hydrocarbon compound such as styrene and α-methylstyrene. The vinyl alicyclic hydrocarbon polymer may be copolymers, such as random copolymer and block copolymer, of vinyl alicyclic hydrocarbon compound or vinyl aromatic hydrocarbon compound with other monomers copolymerizable therewith, and their hydrides. The block copolymer includes di-block, tri-block and larger multi-block copolymers and gradient block copolymer, without special limitation. Molecular weight of the vinyl aliyclic hydrocarbon polymer can appropriately be selected depending on purpose of use, wherein mechanical strength and moldability of the optical film can excellently be balanced, if the polyisoprene- or polystyrene-equivalent weight average molecular weight, measured in a form of cyclohexane solution (toluene solution for insoluble polymer) by gel permeation chromatography, is generally adjusted to a range from 10,000 to 300,000, preferably from 15,000 to 250,000, and more preferably from 20,000 to 200,000.

Glass transition point (Tg) of the polymer mainly composing the above-described optically anisotropic layer may appropriately be selected depending on purpose of use, wherein 80° C. or more is generally preferable, a range from 100° C. to 250° C. is more preferable, and a range from 120° C. to 200° C. is still more preferable. These ranges are preferable in view of excellently balancing heat resistance and moldability.

It is also allowable to mold the above-described polymers to produce the optical film of the present invention. Applicable methods of molding the optical film include hot melt molding and solvent casting. The hot melt molding can further be classified into extrusion molding, press molding, inflation molding, injection molding, blow molding and stretching, wherein of these, extrusion molding, inflation molding and press molding are preferable in view of obtaining the film excellent in the mechanical strength and surface accuracy. Conditions for the molding may appropriately be selected depending on purpose of use, wherein in the hot melt molding, cylinder temperature is generally set to a range from 150 to 400° C., preferably to a range from 200 to 350° C., and still more preferably to a range from 230 to 330° C. Too low temperature of polymer materials worsens the fluidizing property, and results in shrinkage or strain in the obtained film, whereas too high temperature of polymer materials results in molding failures such as void due to decomposition of the polymer, silver streak, and yellowing of the film.

In the present invention, the above-described optically anisotropic layer preferably has an in-plane optical anisotropy. In-plane retardation Re of the optically anisotropic layer preferably falls in a range from 3 to 300 nm, more preferably from 5 to 200 nm, and still more preferably from 10 to 100 nm. Thickness-wise retardation Rth of the optically anisotropic layer preferably falls in a range from 20 to 400 nm, and more preferably from 50 to 200 nm. Thickness of the optically anisotropic layer is preferably 0.1 to 20 μm, more preferably 0.5 to 15 μm, and most preferably 1 to 10 μm.

### (Other Functional Layers)

The optical film of the present invention may have functional layers other than the above-described optically anisotropic layer depending on purpose of use. For example, the optical film having, on the surface of the optically anisotropic layer, a light diffusing layer can exhibit not only optical compensation property, but also light diffusion property, and can further reduce the directional dependence of the display characteristics when applied to the liquid crystal display device.

The optical film of the present invention may also be incorporated into the liquid crystal display device, as being integrated with the polarizing film. In an exemplary case where the optically anisotropic layer is a layer formed by fixing orientation of the liquid-crystalline molecules, the optically anisotropic layer may be formed on the polarizing film or the protective film protecting the polarizing film, using these films as a support. In an exemplary case where the optically anisotropic layer is a polymer film, the optically anisotropic layer may also be intended for the protective film of the polarizing film. Such integrated configuration contributes to thinning of the liquid crystal display device.

### [Polarizing Plate]

In the present invention, it is allowable to use a polarizing plate which comprises a polarizing film and a pair of protective films holding the polarizing film in between. For example, it is allowable to use the polarizing plate obtained by dying the polarizing film, typically made of a polyvinyl alcohol film or the like, with iodine, stretching the film, and being stacked with the protective films on both surfaces thereof. The polarizing plate is disposed external of the liquid crystal cell. It is preferable to dispose a pair of polarizing plates, respectively comprising a polarizing film and a pair of protective films holding the polarizing film in between, so as to hold the liquid crystal cell in between. The protective film disposed on the liquid crystal cell side may be the optical film of the present invention.

### (Protective Film)

The polarizing plate applicable to the present invention is such as having a pair of protective films (also referred to as protective films) stacked on both surfaces of the polarizing film. There are no specific limitations on species of the protective film, wherein applicable examples of which include cellulose esters such as cellulose acetate, cellulose acetate butylate and cellulose propionate; polycarbonate; polyolefin, polystyrene and polyester. As described in the above, it is also allowable to use, as the protective film, a cellulose acylate film satisfying the optical characteristics required for the optical film of the present invention.

The protective film is generally supplied in a roll form, so that it is preferable to continuously bond it to a long polarizing film while keeping agreement between the longitudinal directions of the both. The orientation axis (slow axis) of the protective films may be aligned to any directions, wherein it is preferably aligned in parallel with the longitudinal direction for the convenience of operation.

Retardation of the transparent protective film is preferably small. In an embodiment wherein the transmission axis of the polarizing film and the alignment film of the protective film are not in parallel, it is generally believed that a retardation value of the transparent protective film larger than a predetermined value undesirably converts linear polarization into elliptic polarization due to oblique misalignment of the orientation axis (slow axis) of the protective film. Polymer films having small retardation preferably applicable herein include polyolefins such as cellulose triacetate, Zeonex, Zeonor (both from Zeon Corporation) and ARTON (from JSR Corporation). Other preferable examples include non-birefringent optical polymer materials as described, for example, in Japanese Laid-Open Patent Publication “Tokkaihei” No. 8-110402 or ditto No. 11-293116. For the case where a stack, comprising a support and an optically anisotropic layer composed of a liquid-crystalline compound formed on the support, is used as the optical compensation layer in this embodiment, the protective film may also function as the support of the optically anisotropic layer.

The protective film is preferably bonded to the polarizing film so that the slow axis (orientation axis) of at least one of the protective films (the one disposed closer to the liquid crystal cell when incorporated into the liquid crystal display device) crosses the absorption axis (axis of stretching) of the polarizing film. More specifically, angle between the absorption axis of the polarizing film and the slow axis of the protective film preferably falls in a range from 10° to 90°, more preferably from 20° to 70°, still more preferably from 40° to 50°, and particularly preferably from 43°to 47°. There is no special limitation on angle between the slow axis of the other protective film and the absorption axis of the polarizing film, and can appropriately be set depending on purpose of the polarizing plate, wherein it is preferable to satisfy the above-described ranges, and it is also preferable that the slow axes of the pair of the protective films coincide with each other.

Parallel arrangement of the slow axis of the protective film and the absorption axis of the polarizing film is successful in improving mechanical stability of the polarizing plate, such as prevention of dimensional changes and curling. The same effect can be obtained if at least two axes of three films of the polarizing film and a pair of protective films, that is, the slow axis of one protective film and the absorption axis of the polarizing film, or the slow axes of two protective films, are substantially in parallel with each other.

### <<Adhesive>>

There is no special limitation on an adhesive used between the polarizing film and the protective films, wherein preferable examples thereof include PVA-base polymers (including modified PVA modified by acetoacetyl group, sulfonic acid group, carboxyl group, oxyalkylene group and so forth) and aqueous boron compound solution, and among others, PVA-base polymers are preferable. Dry film thickness of the adhesive is preferably 0.01 to 10 μm, and particularly preferably 0.05 to 5 μm.

### <<Consecutive Fabrication Process of Polarizing Film and Protective Film>>

The polarizing film applicable to the present invention is produced by stretching a film for producing the polarizing film and by allowing it to shrink so as to reduce volatile content, wherein it is preferable to be bonded with a transparent protective film at least on one surface thereof after or during the drying, and subjecting the stack to post-heating. In an embodiment in which the transparent protective film also serves as the support of the optically anisotropic layer functioning as the optical film, the post-heating is preferably carried out after the transparent protective film is bonded on one surface the polarizing film, and a transparent support having the optically anisotropic layer formed thereon is bonded on the opposite surface. Specific methods of bonding include a method of bonding the transparent protective film to the polarizing film using an adhesive during the drying process of the film, while being held at both edges thereof which are slit off after the drying; and a method of drying the film for producing the polarizing film, releasing the film from the edge holder after the drying, slitting both edges of the film off, and bonding the transparent protective film. Methods of slitting may be those generally applied, and include method of using a cutting edge, and laser-assisted cutting. After the bonding, the product is preferably heated in order to dry the adhesive and improve the polarizing properties. Condition of heating may vary depending on the adhesive, wherein a water-base adhesive prefers a temperature of 30° C. or above, 40° C. to 100° C. is more better, and 50° C. to 90° C. is still more better. These process steps are more preferably carried out in a consecutive line in view of product performance and production efficiency.

### ((Performance of Polarizing Plate))

Optical properties and durability (short-term and long-term storability) of the inventive polarizing plate comprising the transparent protective film, polarizer and transparent support are preferably equivalent to, or superior to performances of commercially-available super high contrast products (e.g., HLC2-5618 from Sanritz Corporation). More specifically, the polarizing plate preferably has a visible light transmissivity of 42.5% or more, a degree of polarization of {(Tp−Tc)/(Tp+Tc)}½≧0.9995 (where, Tp is parallel transmissivity and Tc is orthogonal transmissivity), a rate of change in the transmissivity of light before and after being allowed to stand at 60° C., 90% RH for 500 hours and at 80° C. in a dry atmosphere for 500 hours of 3% or less, more preferably 1% or less on the absolute value basis, and a rate of change in the degree of polarization of 1% or less, more preferably 0.1% or less on the absolute value basis.

### EXAMPLE

The following paragraphs will further specifically describe the present invention referring to Examples. It is to be noted that the Examples show only specific examples of the spirit of the present invention, without limiting the present invention.

### Example 1

The liquid crystal display device configured as shown in FIG. 1 was subjected to an optical simulation so as to confirm the effects. The optical calculation was carried out using LCD Master Ver. 6.08 from Shintech, Inc. The liquid crystal cell, electrodes, substrate, polarizing plates and so forth are those conventionally used for liquid crystal display devices. A liquid crystal material used herein for the liquid crystal cell was ZLI-4792 attached to LCD Master. A parallel horizontal orientation with a pre-tilt angle of 3° was adopted to the liquid crystal cell, with a cell gap between the substrates of 3.0 μm, with a liquid crystal material having a positive dielectric anisotropy, and with a retardation (i.e, product Δn·d of the thickness of liquid crystal layer d (μM) and refractive index anisotropy) of 300 nm. The polarizing film used herein was G1220DU attached to LCD Master. Voltage applied to the liquid crystal was 1.0 V for a white state, and 5.3 V for a black state. The optical films (5 and in FIG. 1) used herein were those having the order parameter varying therein so as to make effective profile of the tilt angle correspondent with the liquid crystal layer, so that the retardation of the liquid crystal layer in a black state can optically be compensated also in oblique directions. More specifically, the order parameter of the optical film was determined so as to continuously vary from 0 to 0.8 from the surface thereof closer to the liquid crystal cell towards the surface thereof more distant from the liquid crystal cell, so that the order parameter of the optical film on the side closer to the liquid crystal layer was set in a small range and that on the side more distant from the liquid crystal layer was set in a large range; and Δn of the optical film, assumed as being proportional to the order parameter, was set so as to vary in the thickness-wise direction thereof (direction of z axis in FIG. 1) corresponding to thus-determined order parameter. A light source used herein was a C light attached to LCD Master. In this way, optical characteristics of the liquid crystal display device were determined using a model configuration shown in FIG. 1.

### Comparative Example 1

For the purpose of comparison, the liquid crystal display device similarly configured as described in Example 1, except that the order parameter of the optical film was set constant, was subjected to calculation of optical characteristics using LCD Master.

### <Measurement of Leakage Light and Chromaticity of Liquid Crystal Display Device>

Each of these liquid crystal display devices was applied with voltage for a white state and for a black state, and ratios of transmissivity values between a white state and a black state, or contrast values, were determined at viewing angles of polar angle=60°, and azimuth=0°, 90°, 180° and 270°. Azimuth=0° lies in “+” direction of y axis in FIG. 1, azimuth=90° lies in “−” direction of x axis in FIG. 1, azimuth=180° lies in “−” direction of y axis in FIG. 1, and azimuth=270° lies in “+” direction of x axis in FIG. 1.

Results are shown in Table 1.

### [Table 1]

TABLE 1
Contrast Values Observed at Viewing Angles of Polar
Angle = 60° and Azimuth = 0°, 90°, 180° and 270°

Azimuth

| | 0° | 90° | 180° | 270° |
|---|---|---|---|---|
| Example 1 | 23 | 47 | 23 | 10 |
| Comparative Example 1 | 10 | 5 | 10 | 9 |

It is understood from the results shown in Table 1, that Example 1 having an effectively controlled tilt angle profile of the optical film by varying the order parameter of the optical film in the thickness-wise direction gives a larger contrast value in a black state at a polar angle of 60° in all directions, as compared with Comparative Example 1.

### INDUSTRIAL APPLICABILITY

According to the present invention, it is possible to provide an optical film capable of optical compensation of liquid crystal cells, in particular TN-mode liquid crystal cells, in a black state. The optical film of the present invention exhibits an optical compensation function optically optimized by controlling the order parameter in the direction of thickness. The liquid crystal display device of the present invention is therefore moderated in light leakage in oblique views in a black state, and improved in the viewing-angle-dependent contrast, as compared with those in the prior art.

### CROSS-REFERENCE TO RELATED APPLICATIONS

This application claims benefit of priority to Japanese Patent Application No. 2004-259441 filed Sep. 7, 2004.

1. An optical film comprising an optically anisotropic layer comprising oriented optical elements, wherein the optical elements are oriented in the optically anisotropic layer with an order parameter, which expresses the degree of orientation of said optical elements, varying in the direction of film thickness.

2. The optical film of claim 1, wherein said order parameter is expressed as a function of z, S(z), where the thickness direction of the optically anisotropic layer is along z-axis, z varies from o to d, both ends inclusive, d is thickness of said optically anisotropic layer; and S(z) is a monotonically increasing function, a monotonically decreasing function, or a mixed function thereof.

3. The optical film of claim 2, where the values of S(0), S(d/2) and S(d) are different each other.

4. The optical film of 3 claim 1, wherein said optically anisotropic layer comprises a region in which the optical elements are oriented with an order parameter of 0.

5. The optical film of claim 1, wherein said order parameter varies within a range from 0 to 0.9, both ends inclusive.

6. The optical film of claim 1, wherein said optical elements are discotic or rod like, liquid-crystalline molecules, or polymer molecules.

7. The optical film of claim 1, wherein said optically anisotropic layer is a layer formed of a composition comprising a discotic compound.

8. The optical film of claim 1, wherein said optically anisotropic layer is a layer formed of a composition comprising a rod-like compound.

9. The optical film of claim 1, wherein said optical elements are liquid-crystalline molecules, and said liquid-crystalline molecules are tilted to a layer plane, at an angle varying in the direction of a layer thickness.

10. The optical film of claim 8, wherein said optically anisotropic layer is formed by applying said composition to a surface.

11. The optical film of claim 1, wherein said optically anisotropic layer is formed of a stretched film produced by stretching a polymer film so as to orient said polymer molecules.

12. The optical film of claim 11, wherein said optically anisotropic layer is formed of a stretched film produced by stretching said polymer film by uniaxial stretching, biaxial stretching, or combination thereof.

13. The optical film of claim 11, wherein said polymer film comprises at least one selected from the group consisting of polyamide, polyimide, polyester, polyether-ketone, polyamide-imide, polyester-imide and polyaryl-ether-ketone.

14. The optical film of claim 11, wherein said polymer film at least comprises an alicyclic-structure-containing polymer.

15. The optical film of claim 1, wherein said optically anisotropic layer comprises plural layers.

16. The optical film of claim 1, further comprising at least a light diffusing layer.

17. A polarizing plate comprising a polarizing film and two protective f±]ms disposed on both surfaces thereof, at least one protective film being an optical film of claim 1.

18. A liquid crystal display device comprising a liquid crystal cell, and at least one polarizing plate, said polarizing plate being a polarizing plate of claim 17.

19. A liquid crystal display device comprising a liquid crystal cell, at least one polarizing film, and at least one optical film of claim 1 disposed between said liquid crystal cell and said polarizing film.
